(19) United States
(12) Patent Application Publication
(10) Pub. No.: US 2025/0328149 A1
(43) Pub. Date: Oct. 23, 2025

(54) INTELLIGENT CONTROL METHOD, SELF-MOVING DEVICE AND COMPUTER-READABLE MEDIUM

(71) Applicant: JIANGSU DONGCHENG M&E TOOLS CO., LTD., NANTONG (CN)

(72) Inventors: YUNBO HONG, NANTONG (CN); CHONG WU, NANTONG (CN)

(21) Appl. No.: 19/251,889

(22) Filed: Jun. 27, 2025

Related U.S. Application Data
(63) Continuation-in-part of application No. PCT/CN2024/102315, filed on Jun. 28, 2024.

(30) Foreign Application Priority Data
Sep. 22, 2023 (CN) 202311239604.7

(51) Int. Cl. G05D 1/646; G05D 1/247; G05D 109/10; G05D 111/30

(52) U.S. Cl. CPC G05D 1/646; G05D 1/247; G05D 2109/10; G05D 2111/34

(57) ABSTRACT

The present disclosure provides an intelligent control method performed by a self-moving device. The intelligent control method includes: after the self-moving device exits a station site, moving the self-moving device toward a first identification target; and after the self-moving device reaches the first identification target, moving the self-moving device along the first identification target to acquire a second identification target, where the second identification target is configured to determine a path position at which the self-moving device is located, and the second identification target is different from the first identification target.

### CROSS REFERENCE TO RELATED APPLICATION

The present application is a continuation-in-part of PCT Patent Application No. PCT/CN2024/102315, entitled “PATH PLANNING METHOD, SELF-MOVING DEVICE AND COMPUTER-READABLE MEDIUM,” filed Jun. 28, 2024, which claims priority to Chinese patent application No. 202311239604.7, entitled “PATH PLANNING METHOD, SELF-MOVING DEVICE AND COMPUTER-READABLE MEDIUM,” filed Sep. 22, 2023, each of which is incorporated by reference herein in its entirety.

### TECHNICAL FIELD

The present disclosure relate to the field of intelligent control, and particularly to an intelligent control method, a self-moving device, and a computer-readable medium.

### BACKGROUND

With the development of science and technology, more and more self-moving devices, such as intelligent lawn mowers and sweeping robots, come into people's lives. These self-moving devices bring great convenience to people's production and life.

When in operation, the self-moving device needs a map based on a working area. In order to acquire the map, before the self-moving device works, the self-moving device needs to build a boundary line to define the working area and a non-working area. To accurately construct a path, position data of a start point of the path is important, and an operator equipped with a positioning device usually tries many times in the working area to select, as a position of the start point of the path, an area with a strong signal. This positioning process is cumbersome and features low accuracy, which not only increases the operational difficulty but also greatly reduces the user experience of the self-moving device.

### SUMMARY

In view of the deficiencies in the related art, the present disclosure provides an automated solution which features accurate positioning and simple process.

The present disclosure provides an intelligent control method. The intelligent control method is performed by a self-moving device and includes: after the self-moving device exits a station site, moving the self-moving device toward a first identification target; and after the self-moving device reaches the first identification target, moving the self-moving device along the first identification target to acquire a second identification target, where the second identification target is configured to determine a path position at which the self-moving device is located, and the second identification target is different from the first identification target.

As an improvement, moving the self-moving device toward the first identification target includes: after the self-moving device exits the station site, turning the self-moving device in a preset direction to move toward the first identification target. After the self-moving device reaches the first identification target, the intelligent control method further includes: turning the self-moving device in a preset direction to cause the self-moving device to move along the first identification target.

As an improvement, after the self-moving device acquires the second identification target, the path position indicated by the second identification target is used as a starting position of a path, and the self-moving device is further moved along the first identification target until the self-moving device acquires a third identification target, where the third identification target is configured to indicate a ending position of the path.

As an improvement, the starting position of the path indicated by the second identification target is the same as the ending position of the path indicated by the third identification target.

As an improvement, the starting position of the path indicated by the second identification target differs from the ending position of the path indicated by the third identification target by a predetermined distance.

As an improvement, the predetermined distance is 30 cm to 150 cm. As an improvement, the intelligent control method further includes: moving the self-moving device along the first identification target to collect information of identification points located in the path, where each of the identification points includes a unique identifier.

As an improvement, the first identification target is a boundary line, and the second identification target is a radio frequency identification device (RFID) with a unique identifier.

The present disclosure provides a self-moving device. The self-moving device includes a memory, and a processor. The memory stores a computer program executable by the processor, and the processor is configured to implement, when executing the computer program, the intelligent control method described above.

The present disclosure provides a non-transitory computer-readable medium storing non-volatile program codes executable by a processor. The program codes are configured to cause the processor to implement the intelligent control method described above.

### BRIEF DESCRIPTION OF THE DRAWINGS

FIG. 1 is a first schematic diagram illustrating path planning according to embodiments of the present disclosure.

FIG. 2 is a second schematic diagram illustrating path planning according to embodiments of the present disclosure.

FIG. 3 is a third schematic diagram illustrating path planning according to embodiments of the present disclosure.

FIG. 4 is a schematic structure diagram of a self-moving device of embodiments of the present disclosure.

### DETAILED DESCRIPTION OF THE EMBODIMENTS

Terms used herein are merely used for the purpose of describing particular embodiments and are not intended to limit the present disclosure.

In the related art, to accurately construct a path, position data of the start point of the path is important, and a position of the start point is usually determined based on signal strength or a position of a station site. However, the above manners of determining the position of the start point have the following problems: 1) determining the position of the start point based on the signal strength requires several times of measurement, and this positioning process is cumbersome and features low accuracy; and 2) in the case where the position of the start point is determined based on the position of the station site, the process of determining the position of the station site requires a complex interaction process, and sometimes, the position of the station site cannot be accurately acquired, such as failing to scan a signal indicating the position of the station site. In view of this, the present disclosure provides a novel path planning method, by which a position of a start point of a path can be determined accurately, which is simple without human involvement.

The path planning method in the present disclosure is applied to a self-moving device, and includes: determining a device state of the self-moving device to determine a first identification target based on the device state; the self-moving device moving according to the first identification target; and after exiting a station site, the self-moving device turning to the left rear/right rear and moving towards the boundary line until the self-moving device reaches the boundary line. In some embodiments, the first identification target is a boundary line, and the boundary line may be a physical boundary line, or a virtual boundary line.

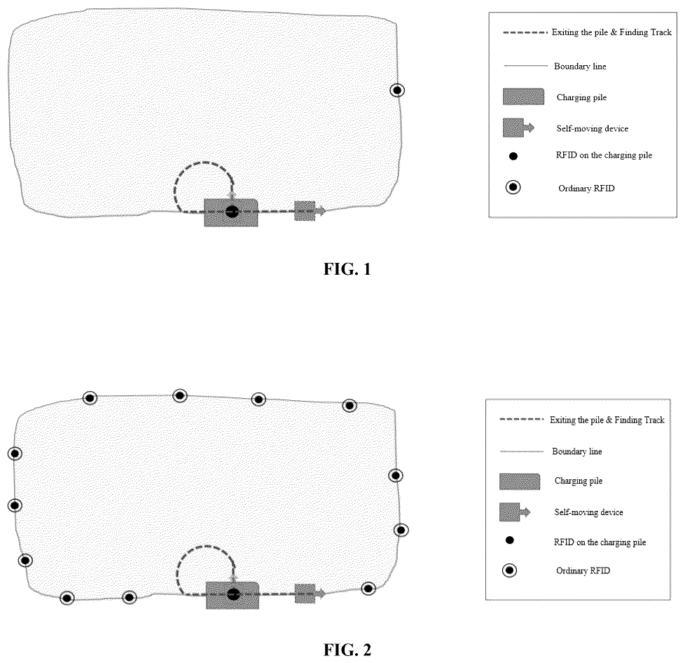

After the self-moving device reaches the first identification target, the self-moving device acquires a second identification target according to a preset rule to determine a position coordinate according to the second identification target. As shown in FIG. 1, after the self-moving device reaches the boundary line, the self-moving device turns in the same direction as when the self-moving device exits the station site. For example, if the self-moving device turns left when exiting the station site, the self-moving device turns left again when arriving at the boundary line; and conversely, if the self-moving device turns right when exiting the station site, the self-moving device turns right again when arriving at the boundary line. Then, the self-moving device continues to travel along the boundary line, and continuously scans for a second identification target during traveling. The second identification target is different from the first identification target. In some embodiments, the second identification target is a radio frequency identification device (RFID).

After the self-moving device exits the station site, the self-moving device determines the position coordinate based on the identification target, thereby realizing the determination of the start point and the end point. In this manner, it can be ensured that a valid and accurate start point is identified by the self-moving device, thereby ensuring the accuracy of path planning and improving the user experience.

In some embodiments, determining the device state of the self-moving device to determine the first identification target based on the device state includes: determining whether the self-moving device is in a state of having exited the station site; and in response to the self-moving device being in the state of having exited the station site, determining the first identification target, where the first identification target is a boundary line. The first identification target is determined by a boundary line signal. The station site is a charging pile/charging station.

In some embodiments, determining whether the self-moving device is in the state of having exited the station site includes: determining a distance between the self-moving device and the station site; and in response to the distance between the self-moving device and the station site being greater than a predetermined threshold, determining that the self-moving device has exited the station site. If the self-moving device determines that the distance between the self-moving device and the station site satisfies a specified condition, it is determined that the self-moving device successfully exits the station site. The specified condition is that the distance is greater than a distance threshold, and the distance threshold is a value within a range of 1 m to 2 m. In some embodiments, determining whether the self-moving device is in the state of having exited the station site includes: determining whether the self-moving device is in a state of charging; and in response to detecting that the self-moving device is not in the state of charging, determining that the self-moving device successfully exits the station site. In some embodiments, determining whether the self-moving device is in the state of having exited the station site includes: in response to the distance between the self-moving device and the station site being greater than the predetermined threshold and the self-moving device being not in the state of charging, determining that the self-moving device successfully exits the station site. In some embodiments, determining whether the self-moving device is in the state of having exited the station site includes: determining whether the self-moving device is signally connected to the station site; and in response to the self-moving device being not signally connected to the station site, determining that the self-moving device successfully exits the station site. In some embodiments, determining whether the self-moving device is in the state of having exited the station site includes: in response to the distance between the self-moving device and the station site being greater than the predetermined threshold and the self-moving device detecting a disconnection of the self-moving device from the station site, determining that the self-moving device successfully exits the station site.

In some embodiments, acquiring the second identification target according to the preset rule includes: the self-moving device moving along the boundary line to acquire a signal of the second identification target. The self-moving device continues to travel along the boundary line, and continuously scans for a second identification target during travel. The second identification target is different from the first identification target. In some embodiments, the second identification target is an RFID.

In some embodiments, the second identification target includes a target module having a first identifier. In the present disclosure, a plurality of RFIDs are arranged on the boundary line, where a characteristic RFID (i.e., the second identification target) located at the station site includes a characteristic identifier, and the other RFIDs are ordinary RFIDs. In some embodiments, each RFID has a 16-bit identification code. In some embodiments, a first bit of the identification code is a preset symbol bit, which belongs to a fixed identifier; and second to fourth bits of the identification code are first tag bits, which are preset special characters. The first label bits are configured to indicate whether the RFID has a first identifier, and the first identifier is configured to indicate that the RFID is located at the station site. In response to the second to fourth bits being “777,” the RFID is located at the station site. In response to the second to fourth bits being not “777,” the RFID is located on the boundary line and is away from the station site, that is, the RFID is an ordinary RFID. The other bits of the identification code are set in the same way as in the related art or according to the actual needs, which are not repeated herein.

In some embodiments, acquiring the second identification target according to the preset rule includes: in response to a first identifier being detected, using a target module having the first identifier as the second identification target. Acquiring the second identification target according to the preset rule to determine the position coordinate according to the second identification target includes: acquiring the second identification target, and using the second identification target as a start point of the path. In response to the self-moving device detecting that first tag bits of an RFID are preset special characters, i.e., a first identifier, it is determined that the RFID is a characteristic RFID at the station site. Then, a position coordinate of the characteristic RFID is identified and used as a position of the start point of the path.

In some embodiments, the path planning method further includes: determining the start point and an end point of the path based on the position coordinate determined by the second identification target. After the self-moving device completes the determination of the start point, the self-moving device continues to move along the boundary line, and records position information of each RFID scanned. When the self-moving device circles back to the charging pile, the self-moving device identifies the characteristic RFID again, and the characteristic RFID identified again is used as the end point. In the present disclosure, the characteristic RFID is utilized for the determination of the start point and the end point of the path without considering the signal strength or the complicated positioning algorithm, and the desired position coordinate can be determined directly by the identification of the characteristic RFID. This manner is simpler and easier to operate, and features higher accuracy.

In some embodiments, a characteristic tag (RFID) distinguished from other tags (RFIDs) is provided at a center position of the charging pile. The self-moving device departs from the charging pile, and one of two cases may occur: 1) the self-moving device successfully identifies the RFID of the charging pile; and 2) the self-moving device fails to identify the RFID of the charging pile. In either of the two cases, the self-moving device will start from the charging pile and walk 1 m to 2 m straight in front of the charging pile, where the specific distance can be set according to the actual demand; after walking straight, the self-moving device stops to turn left and circle around the charging pile, until it detects the boundary line signal; after the self-moving device detects the boundary line signal, the self-moving device goes along the boundary line, passes through the charging pile again, records the position of the RFID of the charging pile as the start point, and starts tracking of the boundary line to build a map. In the process of tracking the boundary line, the self-moving device may also record positions of other detected RFIDs for repositioning. When the self-moving device circles back to the charging pile, the self-moving device detects the charging pile and records the current position as the end point. In some embodiments, when repositioning is required, the coordinate of the start point is used as the coordinate of the end point to ensure the accuracy of the positioning. As a result, the position of the RFID of the charging pile can be accurately identified, and the accurate coordinates of the start point and the end point can be acquired. This method features simple operation, accurate information, and no involvement of a user, and thus the user experience can be significantly improved.

In some embodiments, in order to reduce the error and the number of RFIDs, the RFIDs are arranged on non-corner segments of the boundary line, as shown in FIG. 2. In some embodiments, a distance between adjacent two RFIDs is 5 m to 10 m. In an example, according to the actual site area, the RFIDs may be uniformly arranged along the boundary line. If an RFID is arranged at a corner of the boundary line, the self-moving device may identify the RFID when turning, and records a position coordinate of the RFID. However, when turning, the self-moving device moves along an arc, and it cannot be ensured that the identified RFID is in the center position of the self-moving device, which results in positioning deviation. Therefore, in the present disclosure, the RFIDs are provided on the non-corner segments of the boundary line, thereby improving the accuracy of the position information and reducing the interference error.

The present disclosure further provides another path planning method including all or part of the above path planning method. The path planning method is applied to a self-moving device and includes: determining, by the self-moving device, a second identification target to determine a position coordinate based on the second identification target, and using the position coordinate as a path start point; the self-moving device moving according to a preset rule to collect a path identification point; and after the self-moving device detects the second identification target again, planning, by the self-moving device, a path of the self-moving device according to the position coordinate of the second identification target and the path identification point. In some embodiments, when the self-moving device detects the second identification target again, the self-moving device ends the collection of the path identification point; and the self-moving device plans the path of the self-moving device based on the position coordinate of the second identification target and the path identification point.

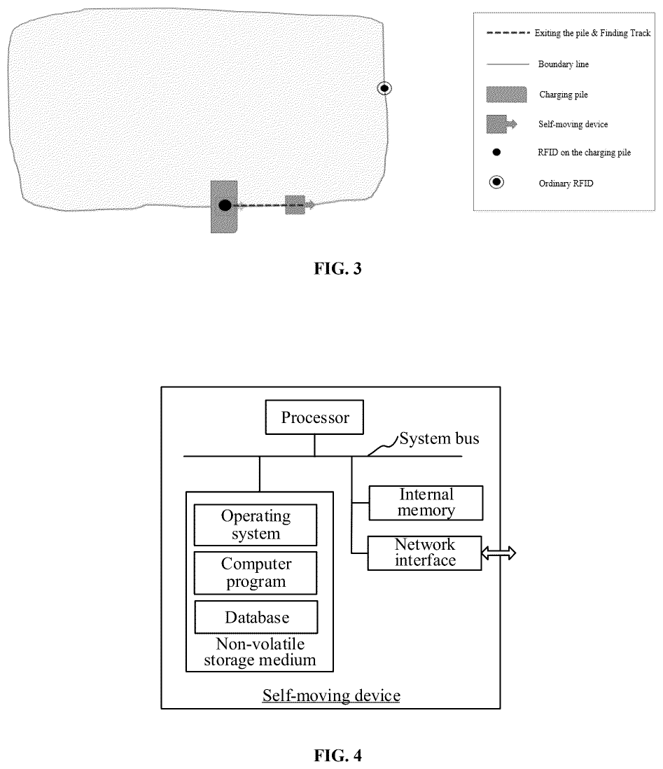

The exit orientation of the station site and the boundary line at the station site may be parallel to each other, as shown in FIG. 3, or may be non-parallel, such as perpendicular, as shown in FIGS. 1-2. If the exit orientation of the station site is parallel to the extension direction of the boundary line, the self-moving device directly walks along the boundary line after exiting the station site. Before exiting the station site, the self-moving device needs to acquire the position coordinate of the second identification target (i.e., the characteristic RFID), and determine the start point of the path based on the position coordinate. The position of the start point of the path can be more accurately determined by introducing the characteristic RFID.

Determining, by the self-moving device, the second identification target further includes: in response to the self-moving device failing to identify the second identification target, determining a device state of the self-moving device to determine a first identification target based on the device state; the self-moving device moving according to the first identification target; and after the self-moving device reaches the first identification target, acquiring a second identification target according to a preset rule to determine a position coordinate based on the second identification target.

As shown in FIG. 1, when the self-moving device reaches the boundary line, the self-moving device turns in the same turning direction as when the self-moving device exits the station site. For example, if the self-moving device turns left when exiting the station site, the self-moving device turns left again after reaching the boundary line. Conversely, if the self-moving device turns right when exiting the station site, the self-moving device turns right again after reaching the boundary line. Then, the self-moving device continues to travel along the boundary line, and continuously scans for a second identification target during travelling. The second identification target is different from the first identification target. In some embodiments, the second identification target is an RFID.

After the self-moving device exits the station site, the self-moving device determines the position coordinate based on the identification target, thereby realizing the determination of the start point and the end point. In this manner, it can be ensured that a valid and accurate start point is identified by the self-moving device, thereby ensuring the accuracy of path planning and improving the user experience.

If the exit direction of the station site is not parallel (e.g., perpendicular) to the boundary line at the station site, when the self-moving device exits the station site, the self-moving device may or may not identify the characteristic RFID. In order to further improve the accuracy of the start point location, when it is detected that the self-moving device successfully exits the station site, the self-moving device may turn left/right according to the preset rule to move towards the boundary line. In some embodiments, after the self-moving device successfully exits the station site, the self-moving device circles with the station site as the center, that is, circling along a preset pattern such as a square, a circle, or an other regular or irregular pattern, with the station site as the center, until the boundary line signal is detected. After the self-moving device detects the boundary line signal, the self-moving device starts to travel along the boundary line. When the self-moving device passes through the station site again, the self-moving device identifies a position coordinate of the characteristic RFID, and uses the position coordinate as the start point of the path. Then, the self-moving device moves along the boundary line to build a boundary map. In some embodiments, when the self-moving device detects an ordinary RFID along the boundary line, the self-moving device records a position coordinate of the ordinary RFID, and when the self-moving device returns to the station site again, i.e., detecting the characteristic RFID, the position coordinate of the characteristic RFID detected for the second time is used as the position coordinate of the end point of the path. In some embodiments, in order to improve the accuracy of positioning, when the characteristic RFID is detected, the position coordinate of the start point is used as a position coordinate of the end point to ensure the accuracy of positioning.

In some embodiments, a starting position of the path is the same as an ending position of the path. In some embodiments, the starting position of the path differs from the ending position of the path by a predetermined distance. In some embodiments, the predetermined distance is 30 cm to 150 cm.

In the present disclosure, a plurality of RFIDs are arranged on the boundary line, where a characteristic RFID (i.e., the second identification target) located at the station site includes a characteristic identifier, and the other RFIDs are ordinary RFIDs. In some embodiments, each RFID has a 16-bit identification code. In some embodiments, a first bit of the identification code is a preset symbol bit, which belongs to a fixed identifier; and second to fourth bits of the identification code are first tag bits, which are preset special characters. The first label bits are configured to indicate whether the RFID has a first identifier, and the first identifier is configured to indicate that the RFID is located at the station site. In response to the second to fourth bits being “777,” the RFID is located at the station site. In response to the second to fourth bits being not “777,” the RFID is located on the boundary line and is away from the station site, that is, the RFID is an ordinary RFID. The other bits of the identification code are set in the same way as in the related art or according to the actual needs, which are not repeated herein.

The present disclosure further provides a self-moving device. As shown in FIG. 4, the self-moving device includes a memory, and a processor. The memory stores a computer program executable by the processor, and the processor is configured to perform the path planning method when executing the computer program. In an embodiment, the self-moving device includes a processor, a memory, a network interface and a database that are connected via a system bus. The processor of the self-moving device is configured to provide computing and control capabilities. The memory of the self-moving device includes a non-volatile storage medium and an internal memory. The non-volatile storage medium stores an operating system, a computer program and a database. The internal memory provides an environment for the operations of the operating system and the computer program in the non-volatile storage medium. The database of the self-moving device is configured to store data. The network interface of the self-moving device is configured to communicate with an external terminal via a network connection. The computer program is configured to implement, when executed by the processor, any one of the methods described above. The self-moving device includes a memory and a processor, where the memory stores a computer program, and the processor is configured to implement, when executing the computer program, any of the operations of the trajectory processing method described above.

The present disclosure further provides a computer-readable medium storing non-volatile program codes executable by a processor. The program codes are configured to cause the processor to implement the path planning method.

Compared with the related art, the present disclosure has beneficial effects described below.

The present disclosure provides a path planning method, a self-moving device and a computer-readable medium. A device state of the self-moving device is determined by the self-moving device to determine a first identification target based on the device state; the self-moving device moves according to the first identification target; and after the self-moving device reaches the first identification target, the self-moving device acquires a second identification target in accordance with a preset rule to determine the position coordinate based on the second identification target. After the self-moving device exits the station site, the self-moving device determines the position coordinate based on the identification target, thereby realizing the determination of the start point and the end point. In this manner, it can be ensured that a valid and accurate start point is identified by the self-moving device, thereby ensuring the accuracy of path planning and improving the user experience.

It is clearly understood by those skilled in the art that for the convenience and conciseness of the description, the specific working process of the above-described system and device can be referred to the corresponding process in the foregoing method embodiments, which are not repeated herein.

If implemented in the form of a software functional unit and sold or used as a standalone product, the described functionality can be stored in a computer-readable storage medium. Based on this understanding, the technical solution of the present disclosure, or a part that contributes to the prior art, or a part of the technical solution, may be embodied in the form of a software product. The software product is stored in a storage medium and includes a number of instructions to cause a computer device (such as a personal computer, a server, or a network device) to perform all or part of the operations of the method described in the various embodiments of the present disclosure. The preceding storage medium includes a USB flash drive, a removable hard disk, a read-only memory (ROM), a random access memory (RAM), a magnetic disk, a compact disk, or an other medium that can store program codes.

It should be noted that the above embodiments are merely implementations of the present disclosure to describe the technical solutions of the present disclosure and are not intended to limit the present disclosure, and the scope of protection of the present disclosure is not limited thereto. Although the present disclosure has been described in detail with reference to the foregoing embodiments, the person of ordinary skill in the art should understand that within the technical scope in the present disclosure, modifications, easily conceivable variations or equivalent substitutions thereof can be made to the technical solutions of the preceding embodiments by any person of skill in the art. These modifications, variations or substitutions do not make the essence of the technical solutions depart from the spirit and scope of the technical solutions of the embodiments of the present disclosure, and shall fall into the scope of protection of the disclosure. Accordingly, the protection scope of the present disclosure shall be subject to the appended claims.

What is claimed is:

1. An intelligent control method, performed by a self-moving device and comprising:
after the self-moving device exits a station site, moving the self-moving device toward a first identification target; and
after the self-moving device reaches the first identification target, moving the self-moving device along the first identification target to acquire a second identification target, wherein the second identification target is configured to determine a path position at which the self-moving device is located, and the second identification target is different from the first identification target.

2. The intelligent control method according to claim 1, wherein moving the self-moving device toward the first identification target includes: after the self-moving device exits the station site, turning the self-moving device in a preset direction to move toward the first identification target; and
wherein after the self-moving device reaches the first identification target, the intelligent control method further includes: turning the self-moving device in a preset direction to cause the self-moving device to move along the first identification target.

3. The intelligent control method according to claim 1, wherein after the self-moving device acquires the second identification target, the path position indicated by the second identification target is used as a starting position of a path, and the self-moving device is further moved along the first identification target until the self-moving device acquires a third identification target, wherein the third identification target is configured to indicate a ending position of the path.

4. The intelligent control method according to claim 3, wherein the starting position of the path indicated by the second identification target is the same as the ending position of the path indicated by the third identification target.

5. The intelligent control method according to claim 3, wherein the starting position of the path indicated by the second identification target differs from the ending position of the path indicated by the third identification target by a predetermined distance.

6. The intelligent control method according to claim 5, wherein the predetermined distance is 30 cm to 150 cm.

7. The intelligent control method according to claim 3, further comprising: moving the self-moving device along the first identification target to collect information of identification points located in the path, wherein each of the identification points includes a unique identifier.

8. The intelligent control method according to claim 1, wherein the first identification target is a boundary line, and the second identification target is a radio frequency identification device (RFID) with a unique identifier.

9. A self-mobile device, comprising a memory and a processor, wherein the memory stores a computer program executable by the processor, and the processor is configured to implement, when executing the computer program, an intelligent control method;
wherein the intelligent control method includes:
after the self-moving device exits a station site, moving the self-moving device toward a first identification target; and
after the self-moving device reaches the first identification target, moving the self-moving device along the first identification target to acquire a second identification target, wherein the second identification target is configured to determine a path position at which the self-moving device is located, and the second identification target is different from the first identification target.

10. The self-mobile device according to claim 9, wherein moving the self-moving device toward the first identification target includes: after the self-moving device exits the station site, turning the self-moving device in a preset direction to move toward the first identification target; and
wherein after the self-moving device reaches the first identification target, the intelligent control method further includes: turning the self-moving device in a preset direction to cause the self-moving device to move along the first identification target.

11. The self-mobile device according to claim 9, wherein after the self-moving device acquires the second identification target, the path position indicated by the second identification target is used as a starting position of a path, and the self-moving device is further moved along the first identification target until the self-moving device acquires a third identification target, wherein the third identification target is configured to indicate a ending position of the path.

12. The self-mobile device according to claim 11, wherein the starting position of the path indicated by the second identification target is the same as the ending position of the path indicated by the third identification target.

13. The self-mobile device according to claim 11, wherein the starting position of the path indicated by the second identification target differs from the ending position of the path indicated by the third identification target by a predetermined distance.

14. The self-mobile device according to claim 13, wherein the predetermined distance is 30 cm to 150 cm.

15. A non-transitory computer-readable medium storing non-volatile program codes executable by a processor, wherein the program codes are configured to cause a processor to implement an intelligent control method;
wherein the intelligent control method includes:
after the self-moving device exits a station site, moving the self-moving device toward a first identification target; and
after the self-moving device reaches the first identification target, moving the self-moving device along the first identification target to acquire a second identification target, wherein the second identification target is configured to determine a path position at which the self-moving device is located, and the second identification target is different from the first identification target.

16. The non-transitory computer-readable medium according to claim 15, wherein moving the self-moving device toward the first identification target includes: after the self-moving device exits the station site, turning the self-moving device in a preset direction to move toward the first identification target; and
wherein after the self-moving device reaches the first identification target, the intelligent control method further includes: turning the self-moving device in a preset direction to cause the self-moving device to move along the first identification target.

17. The non-transitory computer-readable medium according to claim 15, wherein after the self-moving device acquires the second identification target, the path position indicated by the second identification target is used as a starting position of a path, and the self-moving device is further moved along the first identification target until the self-moving device acquires a third identification target, wherein the third identification target is configured to indicate a ending position of the path.

18. The non-transitory computer-readable medium according to claim 17, wherein the starting position of the path indicated by the second identification target is the same as the ending position of the path indicated by the third identification target.

19. The non-transitory computer-readable medium according to claim 17, wherein the starting position of the path indicated by the second identification target differs from the ending position of the path indicated by the third identification target by a predetermined distance.

20. The non-transitory computer-readable medium according to claim 18, wherein the predetermined distance is 30 cm to 150 cm.
